(19) United States
(12) Patent Application Publication
(10) Pub. No.: US 2008/0273901 A1
(43) Pub. Date: Nov. 6, 2008

(54) Developing Device and Image Forming Apparatus Using the Same

(75) Inventors: Hiroshi TOYAMA, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/951,226

(22) Filed: Dec. 5, 2007

(30) Foreign Application Priority Data
Dec. 7, 2006 (JP) 2006-330236
Dec. 7, 2006 (JP) 2006-330237

(51) Int. Cl. G03G 15/08

(52) U.S. Cl. 399/286

(57) ABSTRACT

To provide a developing device capable of preventing excess charge of the toner particles so as to prevent occurrence of failure caused by an decrease in toner flying property between the developing roller and photoconductor or a change in development characteristics, a developing device according to the present invention develops non-magnetic mono component toner using a developing roller having on its surface a plurality of groove portions each of which includes: a leading end side cut portion formed on the leading end side of the developing roller in the rotational direction thereof and having a leading end side cut angle θ1; and a trailing end side cut portion formed on the trailing end side of the developing roller in the rotational direction thereof and having a trailing end side cut angle θ2 and in which a relationship θ1<θ2 is satisfied.

### CROSS REFERENCE TO RELATED APPLICATIONS

This application is based upon and claims the benefit of priority from prior Japanese Patent Applications No. 2006-330236, filed Dec. 7, 2006 and No. 2006-330237, filed Dec. 7, 2006, the entire contents of which are incorporated herein by reference.

### BACKGROUND OF THE INVENTION

1. Field of the Invention

The present invention relates to a developing device performing development using non-magnetic mono component toner through toner jumping phenomenon and an image forming apparatus using the developing device.

2. Description of the Related Art

In an image forming apparatus using non-magnetic mono component toner as disclosed in JP-A-2001-66876, an electrical charge is applied to toner on a developing roller (sleeve) by frictional electrification. In order to effectively generate frictional electrification, that is, in order for the toner to be satisfactorily subjected to friction with the developing roller, blast treatment is applied to the surface of the developing roller to impart a predetermined surface roughness Rz thereto.

However, the surface of the developing roller is ground in the course of the usage of the developing roller to make the surface roughness Rz smaller, with the result that the friction state between the toner and developing roller becomes less satisfactory than that between the toner and a new, unused developing roller. This limits the life of the developing device. The reason that the surface of the developing roller is grounded is that silica, which is externally added to the toner particles, has a very high hardness. In the image forming apparatus of this invention, in order to prolong the life of the developing unit, plating is applied to the surface of the developing roller to make the surface difficult to be ground. However, this method cannot sufficiently prolong the life of the developing unit.

Under the circumstance, in order to prolong the life of the developing device, JP-A-2000-56558 proposes a method in which regular grooves are formed on the developing roller. It has been confirmed that a developing roller having such grooves on the surface thereof has a higher durability than a developing roller having an irregular surface configuration resulting from blasting, leading to prolongation of the life of the developing device. The grooves are formed on the surface of the developing roller in two directions in the invention of JP-A-2000-56558. The reason for this is to prevent the toner particles from moving along one groove to accumulate on one side in the axial direction of a cartridge.

### SUMMARY OF THE INVENTION

However, a new problem has arisen in the development roller having the regular groove shape as disclosed in JP-A-2000-56558. That is, the toner conveyed to the surface of a developing roller clogs in the groove portion and the toner entering the groove cannot be reset. The term “reset” used here means to scrape off, using a supply roller, residual toner particles (old toner particles) that have not been developed on a photoconductor and conveyed back to the developing roller. The supply roller is configured to supply new toner to the developing roller after the reset operation. If the reset operation is not satisfactorily effected, the same toner may always remain on the developing roller. When such residual toner is ground by a regulation blade again and again, toner charge becomes excessively high, decreasing toner flying property between the developing roller and photoconductor or changing development characteristics, which causes failure.

Another disadvantage is that the developing roller having the regular groove shape as disclosed in JP-A-2000-56558 has a reduced toner charging property as compared to a developing roller having an irregular surface configuration. It is estimated that this is because the toner particles on the developing roller having the irregular surface configuration randomly move about on the surface thereof to achieve a satisfactory friction state between the toner and developing roller or enhancing the rolling of the toner particles on the developing roller. FIG. 8 is a view showing the movement of a toner particle on a developing roller having an irregular surface configuration. FIG. 9 is a view showing the movement of a toner particle on a developing roller having a regular surface configuration.

Although it is ideal for all the toner particles to be subjected to uniform friction for charging, the developing roller having a regular surface configuration has a reduced toner charging property as compared to the developing roller having an irregular surface configuration, resulting in frequent generation of poorly charged toner particles. The existence of the poorly charged toner particles (in this case, positively charged toner particles, not negatively charged toner particles) causes overlapping of the toner particles, incurring waste of the toner.

The present invention has been made to solve the above problem and, according to a first aspect of the present invention, there is provided a developing device that develops non-magnetic mono component toner using a developing roller having on its surface a plurality of groove portions each of which includes: a leading end side cut portion formed on the leading end side of the developing roller in the rotational direction thereof and having a leading end side cut angle θ1; and a trailing end side cut portion formed on the trailing end side of the developing roller in the rotational direction thereof and having a trailing end side cut angle θ2, and in which a relationship θ1<θ2 is satisfied.

In the developing device according to the present invention, toner is supplied to the developing roller by a supply roller that rotates in the reverse direction relative to the rotational direction of the developing roller at the nip portion with the developing roller.

According to a second aspect of the present invention, there is provided a developing device that develops non-magnetic mono component toner using a developing roller and a supply roller, the developing roller having on its surface a plurality of groove portions each of which includes: a leading end side cut portion formed on the leading end side of the developing roller in the rotational direction thereof and having a leading end side cut angle θ1; and a trailing end side cut portion formed on the trailing end side of the developing roller in the rotational direction thereof and having a trailing end side cut angle θ2 and in which a relationship θ1>θ2 is satisfied, the supply roller rotating in the same direction as the rotational direction of the developing roller at the nip portion with the developing roller so as to supply toner to the developing roller.

According to a third aspect of the present invention, there is provided an image forming apparatus incorporating a developing device that develops non-magnetic mono component toner using a developing roller having on its surface a plurality of groove portions each of which includes: a leading end side cut portion formed on the leading end side of the developing roller in the rotational direction thereof and having a leading end side cut angle θ1; and a trailing end side cut portion formed on the trailing end side of the developing roller in the rotational direction thereof and having a trailing end side cut angle θ2 and in which a relationship θ1<θ2 is satisfied.

According to a fourth aspect of the present invention, there is provided an image forming apparatus incorporating a developing device that develops non-magnetic mono component toner using a developing roller and a supply roller, the developing roller having on its surface a plurality of groove portions each of which includes: a leading end side cut portion formed on the leading end side of the developing roller in the rotational direction thereof and having a leading end side cut angle θ1; and a trailing end side cut portion formed on the trailing end side of the developing roller in the rotational direction thereof and having a trailing end side cut angle θ2 and in which a relationship θ1>θ2 is satisfied, the supply roller rotating in the same direction as the rotational direction of the developing roller at the nip portion with the developing roller so as to supply toner to the developing roller.

According to the present invention, it is possible to realize a developing device and an image forming apparatus capable of preventing deterioration of the resettability of the toner particles to prevent excess charge of the toner particles, thereby preventing occurrence of failure caused by an decrease in toner flying property between the developing roller and photoconductor or a change in development characteristics.

Further, according to the present invention, it is possible to realize a developing device and an image forming apparatus capable of preventing poor charging of the toner particles to prevent overlapping of the toner particles which incurs waste of the toner.

### BRIEF DESCRIPTION OF THE DRAWINGS

FIG. 1 is a view showing a cross-section of a developing device 100 according to an embodiment of the present invention;

FIG. 2 is a cross-sectional view showing the entire configuration of an image forming apparatus of a tandem type incorporating the developing device 100 according to the embodiment of the present invention;

FIG. 3 is a view showing the vicinity of a developing roller 107 used in the developing device 100 according to the embodiment of the present invention;

FIG. 4 is a view schematically showing grooves formed on the surface of the developing roller 107 used in the developing device 100 according to the embodiment of the present invention;

FIG. 5 is a view schematically showing, in an enlarged manner, a cross-section of the surface of the developing roller 107 used in the developing device 100 according to the embodiment of the present invention;

FIG. 6 is a view schematically showing a cross-section of a contact portion (portion denoted by B in FIG. 3) between the developing roller 107 and a regulation blade 109 used in the developing device 100 according to the embodiment of the present invention;

FIG. 7 is a view schematically showing a cross-section of a contact portion (portion denoted by C in FIG. 3) between the developing roller 107 and a supply roller 105 used in the developing device 100 according to the embodiment of the present invention;

FIG. 8 is a view showing the movement of a toner particle on a developing roller having an irregular surface configuration;

FIG. 9 is a view showing the movement of a toner particle on a developing roller having a regular surface configuration;

FIG. 10 is a view showing the vicinity of the developing roller 107 used in the developing device 100 according to another embodiment of the present invention;

FIG. 11 is a view schematically showing, in an enlarged manner, a cross-section of the surface of the developing roller 107 used in the developing device 100 according to the another embodiment of the present invention; and

FIG. 12 is a view schematically showing a cross-section of a contact portion (portion denoted by C in FIG. 10) between the developing roller 107 and supply roller 105 used in the developing device 100 according to the another embodiment of the present invention.

### DETAILED DESCRIPTION OF THE PREFERRED EMBODIMENTS

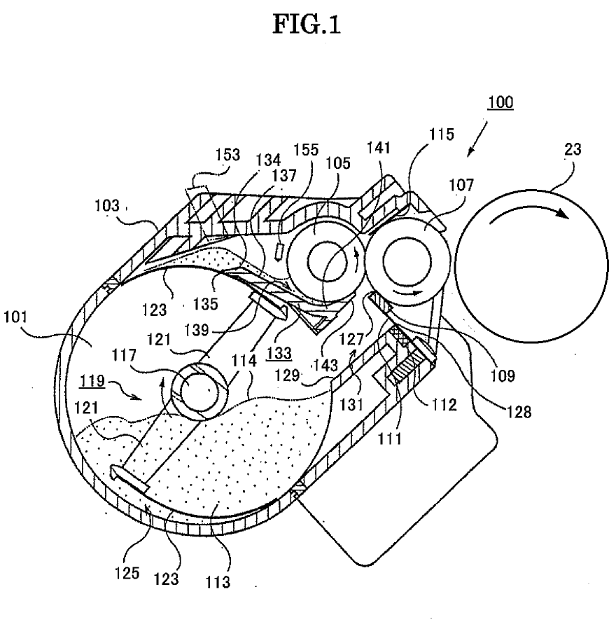

An embodiment of the present invention will be described below with reference to the accompanying drawings. FIG. 1 is a view showing a cross-section of a developing device 100 according to an embodiment of the present invention. The developing device 100 according to the present invention is a unit that performs development using non-magnetic mono component toner through toner jumping phenomenon.

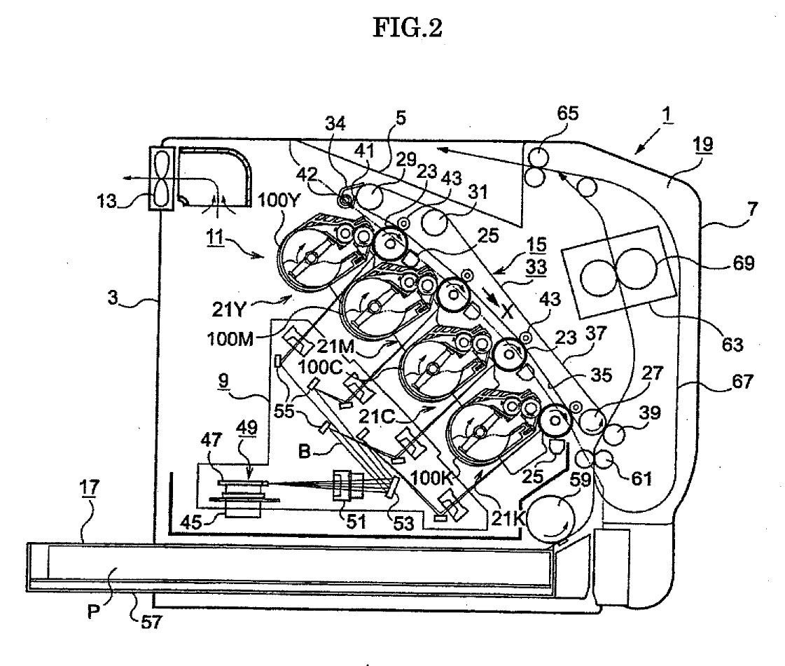

The developing device 100 includes thereinside a housing 103 in which a toner container 101 having substantially a cylindrical shape is provided. Further, a supply roller 105 and a developing roller 107 are set in the housing 103. In a state where the developing device 100 is set in an image forming station (see FIG. 2), the developing roller 107 is adjacently disposed to a photoconductor 23 with a slight interval (e.g., 100 to 300 μm) and is configured to develop a latent image formed on the photoconductor 23 using toner supplied on the circumferential surface thereof while rotating in the direction opposite to the rotational direction (see the arrow in FIG. 1) of the photoconductor 23. Such a developing operation is performed as follows. That is, a developing bias in which an AC voltage is superimposed on a DC voltage is applied from a developing bias source (not shown) to the developing roller 107 so as to make an oscillating voltage act between the developing roller and the photoconductor. Thus, toner is supplied from the developing roller 107 to an electrostatic latent image portion formed in the photoconductor 23, so as to perform development.

The surface of the supply roller 105 is formed of urethane sponge. The supply roller 105 can rotate in the same direction (counterclockwise direction in FIG. 1) as the developing roller 107 in a state where the circumferential surface of the supply roller 105 is in contact with the developing roller 107. A voltage equal to the developing bias voltage applied to the developing roller 107 is applied to the supply roller 105.

A regulation blade 109 is always brought into pressure contact with the developing roller 107 uniformly all over the lengthwise range of the circumferential surface of the developing roller 107 by the action of a plate spring member 111 and an elastic member 112 provided on the lower side of the plate spring member 111. Thus, the regulation blade 109 scrapes excess toner of the toner adhering to the circumferential surface of the developing roller 107 so that a constant volume of toner is carried on the circumferential surface of the developing roller 107. In addition, the regulation blade 109 also charges toner 113 properly.

The scraped toner falls freely to be mixed into the toner 113 in the toner container 101. This point will be described in detail later. In addition, a seal member 115 is provided so that one end thereof is fixed to the housing 103 while the other end thereof is brought into pressure contact with the upper side of the circumferential surface of the developing roller 107. Thus, the toner 113 in the housing 103 is prevented from flying to the outside.

An agitator 119 is provided in the toner container 101 so as to rotate clockwise in FIG. 1 around a rotating shaft 117. The agitator 119 has two arm members 121 extending in directions reverse to each other with the rotating shaft 117 serving as a rotation center. The arm members 121 are set to be a slight shorter than the diameter of the circle in section of the toner container 101. An agitating fin 123 extends from the forward end of each of the arm members 121 in a direction reverse to the rotation direction of the agitator 119. The agitating fin 123 is made of a sheet member having flexibility. The elastic force caused by the flexibility brings the forward end side of the agitator fin 123 into pressure contact with the inner circumferential surface of the cylindrical toner container 101. With such a configuration, when the agitator 119 rotates, the toner 113 in an area 125 between the inner circumferential surface of the toner container 101 and corresponding one of the agitating fins 123 is scooped up with the agitating fin 123 so that the scooped toner 113 can be conveyed onto a toner guide member which will be described later.

A top surface 114 of the toner 113 received in the toner container 101 is set to be lower than a place 127 where the regulation blade 109 abuts against the circumferential surface of the developing roller 107. This setting is done for the following reason. That is, if the toner volume were large enough to bury the regulation blade 109, the toner scraped by the regulation blade 109 would be close to the regulation blade so that the circulating path for returning the toner into the toner container 101 would be blocked. In addition, the function of that the regulation blade 109 scrapes excess toner from the developing roller 107 to thereby control the volume of toner to be conveyed to a developing area and the function that the regulation blade 109 charges toner properly would be blocked.

More specifically, the top surface 114 of the toner 113 received in the toner container 101 is set to be lower than the lower end of the regulation blade 109, and the upper limit of the position of the top surface 114 is placed on the position of an intersecting point 128 between the plate spring member 111 and the elastic member 112. If the top surface 114 of the toner 113 in the toner container 101 were located above the intersecting point 128, the motion of the plate spring member 111 might be put under restraint. Thus, there might be a probability that a proper control pressure could not be obtained. As a result, “function of carrying a constant volume of toner on the circumferential surface of the developing roller 107” or the “function of charging the toner properly” might be blocked. However, as described above, when the upper limit of the position of the top surface 114 of the toner 113 is placed on the position of the intersecting point 128, it is possible to eliminate the probability that the respective functions are blocked.

Between the place 127 where the regulation blade 109 abuts against the circumferential surface of the developing roller 107 and the top surface 114 of the toner 113 received in the toner container 101, a toner guide surface 129 is formed as a part of the housing 103. The toner guide surface 129 is inclined obliquely to the top surface 114 of the toner at an inclination angle not smaller than the repose angle of the toner 113. The toner guide surface 129 has a function of guiding the toner 113 scraped from the circumferential surface of the developing roller 107 by the regulation blade 109 into the toner container 101.

The toner 113 scraped from the circumferential surface of the developing roller 107 by the regulation blade 109 does not have to be always guided into the toner container 101 by the toner guide surface 129. The scraped toner 113 may be designed to fall into the toner container 101 directly. To this end, a toner guide space 131 in which the toner 113 scraped from the circumferential surface of the developing roller 107 by the regulation blade 109 is introduced into the toner container 101 is formed under the place 127 where the regulation blade 109 abuts against the circumferential surface of the developing roller 107.

A toner guide member 133 is provided above the toner container 101. The toner guide member 133 has a scraper 135, a flat conveying portion 137, a curved portion 141 and a contact portion 143. The scraper 135 is provided in an end portion 134 more distant from the supply roller 105 and formed to be acute enough to scrape the toner 113 conveyed by the agitating fins 123. The top surface side of the flat conveying portion 137 is formed to be flat and inclined at an angle not smaller than the repose angle of the toner 113 toward the supply roller 105 rather than toward the scraper 135. The curved portion 141 is formed on the downstream side of the flat conveying portion 137 so as to be curved to form a concave surface on its upper side. The contact portion 143 is formed on the downstream side of the curved portion 141 so as to abut against the circumferential surface of the supply roller 105 with a linear pressure set properly. The toner guide member 133 is formed so that the surface roughness of the toner guide member 133 including the flat conveying portion 137, the curved portion 141 and the contact portion 143 is lower than the average particle size of the toner.

In addition, by the presence of the contact portion 143, the toner 113 adhering to the under-side surface of the supply roller 105 falls by gravitation so that the volume of toner which can be supplied to the developing roller can be prevented from being reduced. Thus, the image density can be prevented from being lowered. In addition, a temporal toner storage 139 whose section is narrowed like a wedge is formed between the curved portion 141 and the circumferential surface of the supply roller 105. Here, the phrase “section is narrowed like a wedge” means that the section on the entrance side is relatively wide while the section is narrowed as it goes in the traveling direction of the toner, and the section on the tip side of the wedge becomes narrow enough for the toner not to fall freely.

In the toner guide member 133 shaped thus, the toner 113 conveyed by the agitating fins 123 is scraped by the scraper 135. After that, the scraped toner 113 falls by gravitation along the flat conveying portion 137 at a uniform speed all over its widthwise range and at any place of its inclination-direction range so that the toner is once stored in the temporal toner storage 139. In the temporal toner storage 139 narrowed like a wedge, with the advance of the toner 113 to the narrower area, the pressure contact force against the circumferential surface of the supply roller 105 increases gradually so that the toner 113 is pressed onto the circumferential surface of the supply roller 105. Thus, it becomes easier to carry the toner 113 on the circumferential surface. Incidentally, when the toner 113 is pushed out from the contact portion 143, the toner 113 falls in the toner guide space 131 so as to be returned to the toner container 101 directly or by the guidance of the toner guide surface 129.

A color image forming apparatus incorporating the developing device according to the present invention will next be described. FIG. 2 is a cross-sectional view showing the entire configuration of the image forming apparatus of a tandem type incorporating the developing device according to the embodiment of the present invention. In FIG. 2, an image forming apparatus 1 has a housing 3, a paper discharge tray 5 and a door body 7. The paper discharge tray 5 is formed above the housing 3. The door body 7 is openably provided in front of the housing 3. An exposure unit 9, an image forming unit 11, an air fan 13, a transfer belt unit 15 and a paper feeding unit 17 are disposed in the housing 3. A paper conveying unit 19 is disposed in the door body 7.

The image forming unit 11 has four image forming stations 21 in which four developing devices receiving different color toners can be set. Incidentally, the four image forming stations 21 are used for developing devices for yellow, magenta, cyan and black respectively, and these stations are distinguished in FIG. 2 by the reference numerals 21Y, 21M, 21C and 21K respectively. Each of the image forming stations 21Y, 21M, 21C and 21K includes a photoconductor 23, a corona charger 25 provided around the photoconductor 23, and a developing device 100 according to the invention.

The transfer belt unit 15 includes a driving roller 27, a driven roller 29, a tension roller 31, an intermediate transfer belt 33 and a cleaner 34. The driving roller 27 is driven to rotate by a not-shown drive source. The driven roller 29 is disposed obliquely above the driving roller 27. The intermediate transfer belt 33 is laid among the rollers 27, 29 and 31 so as to be driven to circulate in a counterclockwise direction X in FIG. 2. The cleaner 34 abuts against the surface of the intermediate transfer belt 33. The driven roller 29, the tension roller 31 and the intermediate transfer belt 33 are disposed in parallel so as to be inclined with respect to the driving roller 27. Thus, when the intermediate transfer belt 33 is driven, a belt surface 35 in which the belt conveying direction X looks downward is located on the lower side, while a belt surface 37 in which the conveying direction looks upward is located on the upper side.

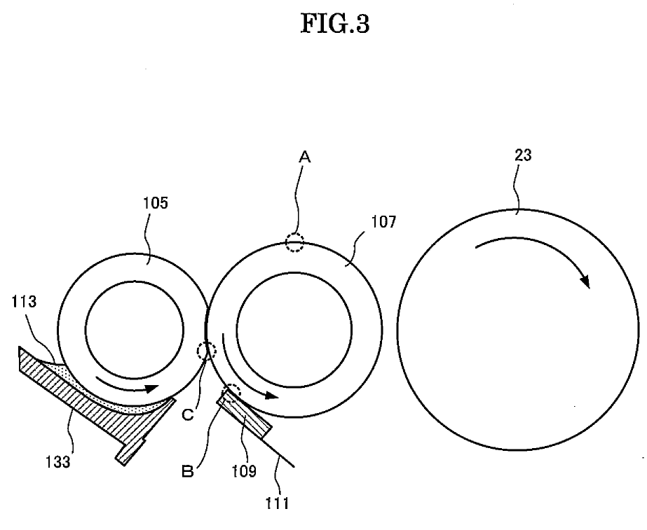

The photoconductors 23 are brought into pressure contact with the belt surface 35 along an arched line, so as to be driven to rotate in the directions shown by the arrows in FIG. 3, respectively. The tension of the intermediate transfer belt 33, the curvature of the arched line, and so on, can be controlled by adjusting the position of the tension roller 31.

The driving roller 27 also has a function as a backup roller for a secondary transfer roller 39. A rubber layer which has, for example, a thickness of about 3 mm and a volume resistivity of not higher than 105 Ω·cm is formed on the circumferential surface of the driving roller 27, and grounded through a metal shaft. Thus, the rubber layer is formed as a conductive path for secondary transfer bias supplied through the secondary transfer roller 39. In addition, the diameter of the driving roller 27 is made smaller than the diameter of the driven roller 29 and the diameter of the tension roller 31. Thus, recording paper can be easily released by the elastic force of the recording paper per se after secondary transfer. The driven roller 29 also serves as a backup roller for the cleaner 34.

The cleaner 34 is provided on the side of the belt surface 35 having a downward conveying direction. The cleaner 34 has a cleaning blade 41 for removing toner staying on the surface of the intermediate transfer belt 33 after secondary transfer, and a toner conveying path 42 for conveying the recovered toner. The cleaning blade 41 abuts against the intermediate transfer belt 33 in the portion where the intermediate transfer belt 33 is wound on the driven roller 29. In addition, primary transfer members 43 abut against the back surface of the intermediate transfer belt 33 so as to face the photoconductors 23 of the image forming stations 21Y, 21M, 21C and 21K. A transfer bias is applied to the primary transfer members 43.

The exposure unit 9 is disposed in a space formed obliquely under the image forming unit 11. The air fan 13 is disposed obliquely above the exposure unit 9. The paper feeding unit 17 is disposed under the exposure unit 9. A scanner 49 constituted by a polygon mirror motor 45 and a polygon mirror 47 is disposed vertically in the bottom portion of the exposure unit 9. In addition, a single f−θ lens 51 and a reflecting mirror 53 are disposed in an optical path B. Further, a plurality of turning mirrors 55 are disposed above the reflecting mirror 53 so as to make scanning optical paths for the respective colors turn back to the photoconductors 23, respectively, in no parallel with one another.

In the exposure unit 9, image signals corresponding to the respective colors are emitted from the polygon mirror 47 in the form of laser beams modulated on the basis of a common data clock frequency. The photoconductors 23 of the image forming stations 21Y, 21M, 21C and 21K are irradiated with the laser beams passing through the f−θ lens 51, the reflecting mirror 53 and the turning mirrors 55 so that latent images are formed on the photoconductors 23, respectively. The length of optical path between the polygon mirror 47 of the exposure unit 9 and the photoconductor 23 for one image forming station 21 is set to be substantially equal to that for another image forming station 21. Accordingly, the scanning width of the optical beam scanned in one optical path becomes substantially equal to that in another optical path. It is therefore unnecessary to provide a special configuration for forming image signals. Thus, laser light sources can form modulated signals based on the common data clock frequency though the signals are modulated with different image signals correspondingly to different color images. Color shift caused by a relative difference in the sub-scanning direction is prevented because the common reflecting surface is used. It is therefore possible to arrange a color image forming apparatus which is simple in structure and low in cost.

The air fan 13 serves as a cooler. The air fan 13 introduces the air in the arrow direction in FIG. 2 so as to release the heat from the exposure unit 9 and other heat generating members. Thus, the temperature rise of the polygon mirror motor 45 is suppressed so that the image quality can be prevented from being deteriorated while the life of the polygon mirror motor 45 can be prolonged.

The paper feeding unit 17 has a paper feed cassette 57 and a pickup roller 59. In the paper feed cassette 57, a stack of recording media P are retained. The recording media P are fed one by one from the paper feed cassette 57 by the pickup roller 59. The paper conveying unit 19 has a pair of gate rollers 61, a secondary transfer roller 39, a fixer 63, a pair of paper discharge rollers 65, and a double-sided print conveying path 67. The pair of gate rollers 61 define the paper feed timing of the recording media P to the secondary transfer portion. The secondary transfer roller 39 is brought into pressure contact with the driving roller 27 and the intermediate transfer belt 33.

The fixer 63 has a pair of rotatable fixing rollers 69, and a pressure applier. At least one of the fixing rollers 69 includes a heating member such as a halogen heater. The pressure applier applies pressure to at least one of the fixing rollers 69 so as to urge it toward the other fixing roller, so that a secondary image secondary-transferred to a sheet material is pressed onto the recording medium P. The secondary image secondary-transferred to the recording medium is fixed on the recording medium at a predetermined temperature in a nip portion formed by the pair of fixing rollers 69.

The developing devices 100 according to the invention are types in which the toner is circulated and set in the image forming stations 21Y, 21M, 21C and 21K, respectively, in use. These developing devices have the same configuration fundamentally.

The groove shape formed on the surface of the developing roller 107 of the developing device 100 according to the embodiment of the present invention will next be described. FIG. 3 is a view showing the vicinity of the developing roller 107 used in the developing device 100 according to the embodiment of the present invention.

The developing roller 107 and photoconductor 23 are slightly spaced apart from each other by a spacer member and rotate in the opposite directions to each other as denoted by the arrows in FIG. 3. In a development area where the developing roller 107 and photoconductor 23 are opposed to each other, the circumferential surfaces thereof are moved in the same direction (from downward to upward), and a developing bias in which an AC voltage is superimposed on a DC voltage is applied from a developing bias source to the developing roller 107 so as to make an oscillating electric field act between the developing roller 107 and the photoconductor 23. Thus, the toner 113 is supplied from the developing roller 107 to an electrostatic latent image portion formed in the photoconductor 23, so as to perform development (jumping development).

In the developing device using non-magnetic mono component toner, it is necessary to properly charge the toner 113 in order to generate such jumping development. To this end, the regulation blade 109 is elastically brought into pressure contact with the developing roller 107 by the action of a plate spring member 111 so as to charge the toner 113 adhering to the circumferential surface of the developing roller 107.

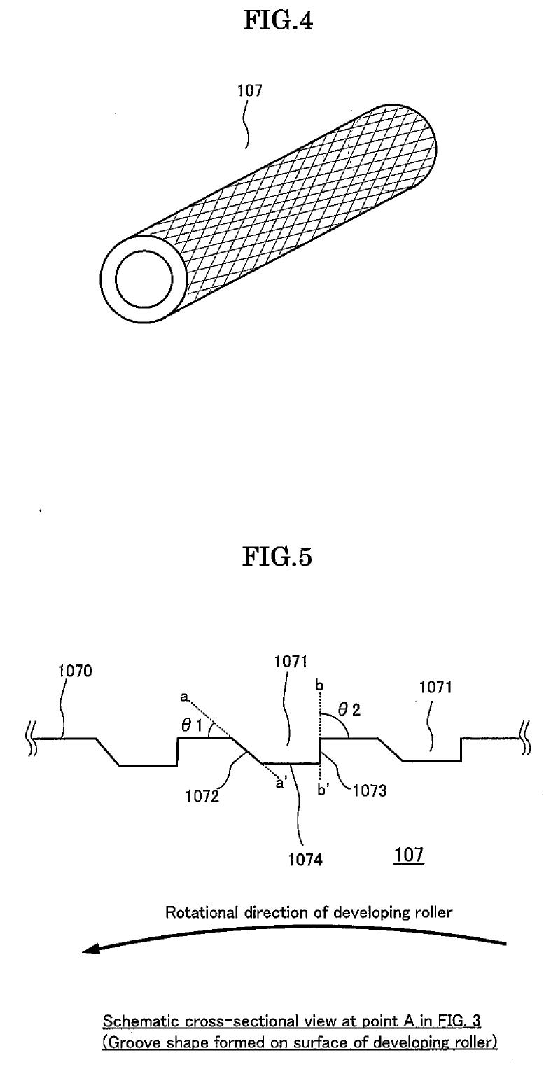

FIG. 4 is a view schematically showing grooves formed on the surface of the developing roller 107 used in the developing device 100 according to the embodiment of the present invention. The surface of the developing roller 107 shown in FIG. 4 is merely an illustration for easy understanding and differs from the actual one in the groove pitch. Such grooves formed on the surface of the developing roller 107 can be formed using a method disclosed in JP-A-2000-56558.

FIG. 5 is a view schematically showing, in an enlarged manner, a cross-section of the surface of the developing roller 107 at the point A shown in FIG. 3. As shown in FIG. 5, a plurality of grooves having different cutting angles are formed on the surface of the developing roller 107 at an appropriate pitch. In FIG. 5, reference numerals 1070, 1071, and 1074 denote a superficial portion of the developing roller 107, a groove portion thereof, and a groove bottom surface, respectively. The rotational direction of the developing roller 107 is denoted by the arrow in FIG. 5. This arrow also defines “leading end” and “trailing end” described below with respect to the rotation direction of the developing roller 107. That is, in FIG. 5, a reference numeral 1072 denotes a leading end side cut portion of the groove portion 1071 and reference numeral 1073 denotes a trailing end side cut potion of the groove portion 1071.

A leading end side cutting angle θ1 of the leading end side cut portion 1072 of the groove portion 1071 is defined by the superficial portion 1070 of the developing roller 107 and a line a-a′ passing through the leading end side cut portion 1072 as shown in FIG. 5. Further, a trailing end side cutting angle θ2 of the trailing end side cut portion 1073 of the groove portion 1071 is defined by the superficial portion 1070 of the developing roller 107 and a line b-b′ passing through the trailing end side cut portion 1073 as shown in FIG. 5.

In the developing roller 107 used in the developing device 100 according to the embodiment, the groove portion 1071 is formed such that (leading end side cutting angle θ1)<(trailing end side cutting angle θ2) is satisfied. Note that, in the present embodiment, the groove bottom surface 1074 need not be formed, as long as a groove portion satisfying the above relationship “(leading end side cutting angle θ1)<(trailing end side cutting angle θ2)” is formed.

Advantages obtained by forming the groove satisfying the above relationship on the developing roller 107 will next be described.

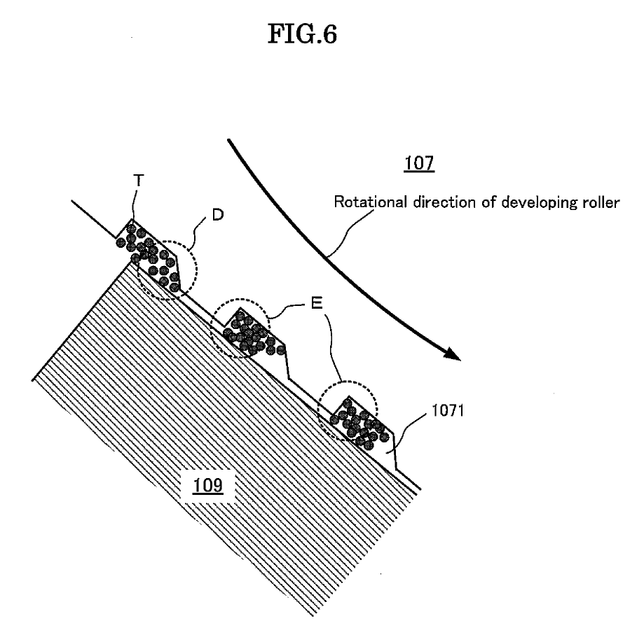

FIG. 6 is a view schematically showing a cross-section of a contact portion (portion denoted by B in FIG. 3) between the developing roller 107 and regulation blade 109 used in the developing device 100 according to the embodiment of the present invention. In FIG. 6, a reference symbol T schematically denotes toner particles. With reference to FIG. 6, a mechanism for enhancing charging property of the toner particles T in the developing device 100 according to the embodiment of the present invention will be described.

In the contact portion between the developing roller 107 and regulation blade 109, the toner particles T are friction charged in the groove portion 1071 of the developing roller 107 while the amount of the toner particles T is controlled by the regulation blade 109. Since the groove portion 1071 having the leading end side cut portion 1072 and trailing end side cut portion 1073 in which the relationship “(leading end side cutting angle θ1)<(trailing end side cutting angle θ2)” is established is formed in the developing roller 107 according to the present embodiment, the toner particles T easily enter the groove portion 1071 and are difficult to go out of the groove portion 1071 (see D and B in FIG. 6).

As shown by E in FIG. 6, a strong resistance force against the toner particles T that are intend to go out of the groove portion 1071 is generated in the trailing end side cut portion 1073, with the result that the toner particles T are strongly scraped by the regulation blade 109 and, thereby, the charging property of the toner particles T is enhanced.

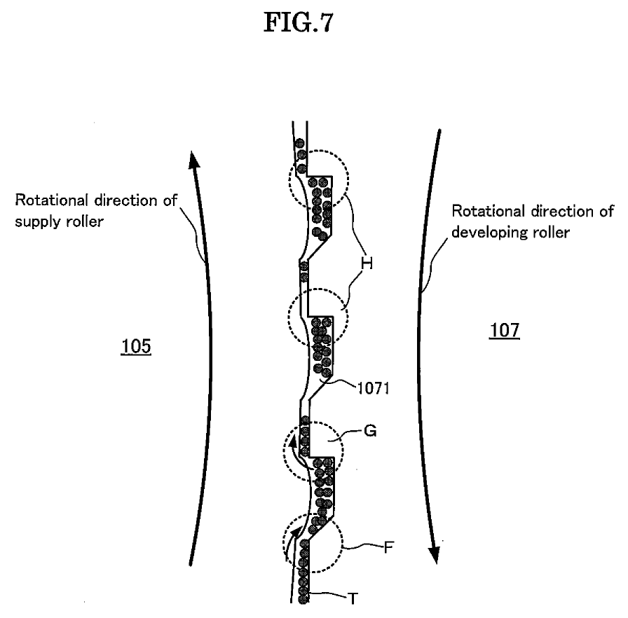

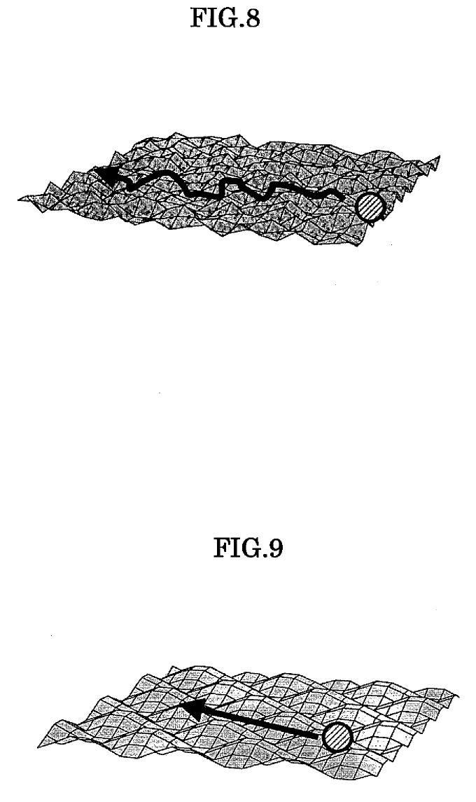

FIG. 7 is a view schematically showing a cross-section of a contact portion (portion denoted by C in FIG. 3) between the developing roller 107 and supply roller 105 used in the developing device 100 according to the embodiment of the present invention. In FIG. 7, a reference symbol T schematically denotes toner particles. With reference to FIG. 7, a mechanism for enhancing resettability of the toner particles T in the developing device 100 according to the embodiment of the present invention will be described.

The groove portion 1071 having the leading end side cut portion 1072 and trailing end side cut portion 1073 in which the relationship “(leading end side cutting angle θ1)<(trailing end side cutting angle θ2)” is established is formed in the developing roller 107 according to the present embodiment. In the present embodiment, the resettability of the toner particles T is enhanced using the relationship of the angle on the leading end side and that on the trailing end side and a supply method of the toner particles T in the supply roller 105.

In the present embodiment, the toner particles T are supplied to the developing roller 107 by counter rotation of the supply roller 105 relative to the developing roller 107. That is, the developing roller 107 and supply roller 105 are rotated in the reverse directions to each other at the nip portion between them to supply the toner particles T from the supply roller 105 to developing roller 107.

The groove portion 1071 of the developing roller 107 has the leading end side cut portion 1072 and trailing end side cut portion 1073 in which the relationship θ1<θ2 is satisfied. With this configuration, as shown in by F in FIG. 7, new toner particles T can easily be supplied to the groove portion 1071. When new toner particles T enter the groove portion 1071 as shown by F in FIG. 7, old toner particles T are expected to be pushed out from the groove portion 1071 as shown by G in FIG. 7. The old toner particles T means toner particles that have not been developed on the photoconductor 23 and conveyed back to the developing roller 107.

As described above, according to the present embodiment, it is possible to realize a developing device and an image forming apparatus capable of preventing deterioration of the resettability of the toner particles to prevent excess charge of the toner particles, thereby preventing occurrence of failure caused by an decrease in toner flying property between the developing roller and photoconductor or a change in development characteristics.

Further, according to the present embodiment, it is possible to realize a developing device and an image forming apparatus capable of preventing poor charging of the toner particles to prevent overlapping of the toner particles which incurs waste of the toner.

### EXAMPLE 1

As the developing roller 107 for the developing device 100 according to the present embodiment, a developing roller having a groove portion in which the leading end side cutting angle θ1=30° and trailing end side cutting angle θ2=60° was produced. Further, as a developing roller for the developing device 100 according to a comparative example, a developing roller having a groove portion in which the leading end side cutting angle θ1=45° and trailing end side cutting angle θ2=45° was produced. The groove pitch of both the developing rollers was set to 80 μm.

The developing device 100 according to the present embodiment and the developing device 100 according to the comparative example respectively incorporating the above developing rollers were mounted in the image forming apparatus 1 shown in FIG. 2 to perform a print test under the conditions described below

### (Driving Speed)

Photoconductor: 200 mm/sec
Developing roller: 300 mm/sec

(with rotation at the nip portion in the same direction with the photoconductor)
Supply roller: 225 mm/sec

(counter rotation at the nip portion with the developing roller)

### (Developing Bias, etc.)

Vdc (direct current component): −300 V
Vpp (alternating current, voltage between peaks): 1400 V
Frequency: 3 KHz
Duty (ratio of plus-side component): 60%
Waveform: rectangular wave
Developing gap: 140 μm

The results of the print test under the above conditions were obtained as follows.
(Developing device 100 according to the present embodiment) Solid image density: OD value 1.5, blurring did not occur Overlapped amount (weight per 1000 sheets): 3 g
(Developing device 100 according to the comparative example) Solid image density: OD value 1.1, blurring occurred Overlapped amount (weight per 1000 sheets): 3 g

The obtained results will be discussed below. In the developing device according to the present embodiment, a satisfactory solid image density was obtained. It is estimated that this is because agitation between new toner particles and old toner particles was satisfactorily conducted to enhance the resettability, which prevents excess charge of the toner particles to maintain good flying property. On the other hand, in the developing device according to the comparative example, supply of the toner particles was not satisfactorily conducted, so that blurring occurred in sold printing to result in insufficient image density.

Further, a white solid image was printed on 1000 sheets, and overlapped amount was obtained by measuring the weight of the developing device before and after the printing. The more the amount of poorly charged toner particles (having reverse polarity, in this case positively charged), the more the overlapped amount increases, resulting in waste of the toner. In the developing device according to the present embodiment, waste toner consumption amount per 1000 sheet was as small as 3 g, that is, a satisfactory result was obtained. This is because that the toner particles were favorably charged to suppress the amount of poorly charged toner particles. On the other hand, in the developing device according to the comparative example, waste toner consumption amount per 1000 sheet was as large as 15 g.

Another embodiment of the present invention will next be described. Although the rotation direction of the supply roller 105 and groove shape formed on the surface of the developing roller 107 are different from those of the above embodiment, the other points are the same as the preceding embodiment, and the description of the preceding embodiment is incorporated herein.

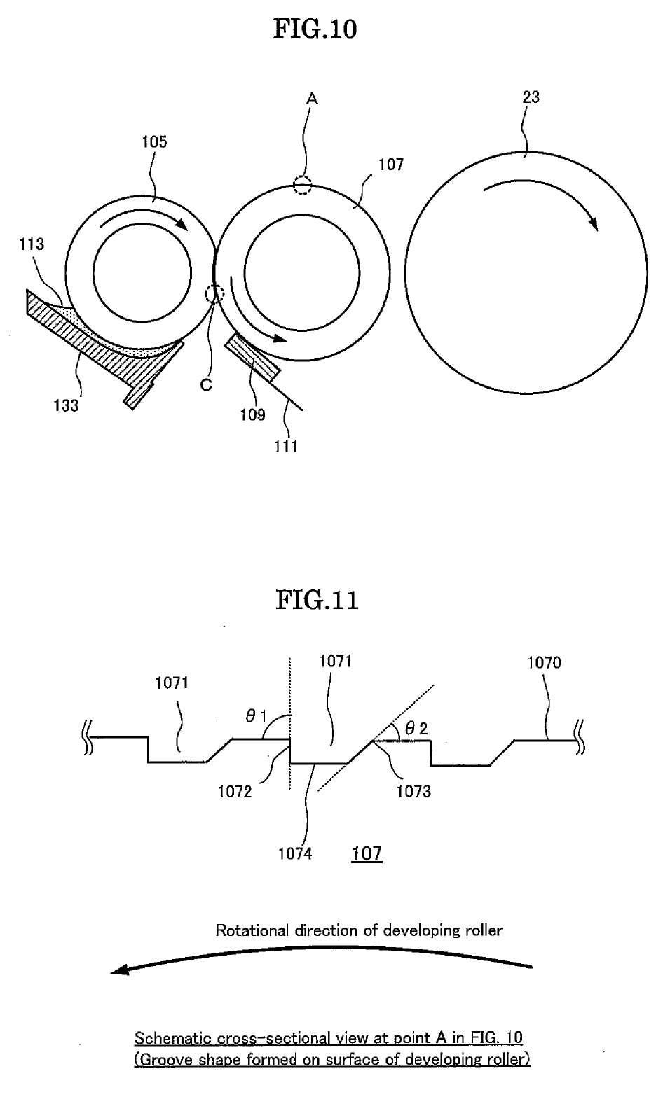

The groove shape formed on the surface of the developing roller 107 of the developing device 100 according to the another embodiment of the present invention will next be described. FIG. 10 is a view showing the vicinity of the developing roller 107 used in the developing device 100 according to the another embodiment of the present invention.

The developing roller 107 and the photoconductor 23 are slightly spaced apart from each other by a spacer member and rotate in the opposite directions to each other as denoted by the arrows in FIG. 10. In a development area where the developing roller 107 and photoconductor 23 are opposed to each other, the circumferential surfaces thereof are moved in the same direction (from downward to upward), and a developing bias in which an AC voltage is superimposed on a DC voltage is applied from a developing bias source to the developing roller 107 so as to make an oscillating electric field act between the developing roller 107 and the photoconductor 23. Thus, the toner 113 is supplied from the developing roller 107 to an electrostatic latent image portion formed in the photoconductor 23, so as to perform development (jumping development).

In the developing device using non-magnetic mono component toner, it is necessary to properly charge the toner 113 in order to generate such jumping development. To this end, the regulation blade 109 is elastically brought into pressure contact with the developing roller 107 by the action of a plate spring member 111 so as to charge the toner 113 adhering to the circumferential surface of the developing roller 107.

FIG. 11 is a view schematically showing, in an enlarged manner, a cross-section of the surface of the developing roller 107 at the point A shown in FIG. 10. As shown in FIG. 11, a plurality of grooves having different cutting angles are formed on the surface of the developing roller 107 at an appropriate pitch. In FIG. 11, reference numerals 1070, 1071, and 1074 denote a superficial portion of the developing roller 107, a groove portion thereof, and a groove bottom surface, respectively. The rotational direction of the developing roller 107 is denoted by the arrow in FIG. 11. This arrow also defines “leading end” and “trailing end” described below with respect to the rotation direction of the developing roller 107. That is, in FIG. 11, a reference numeral 1072 denotes a leading end side cut portion of the groove portion 1071 and reference numeral 1073 denotes a trailing end side cut potion of the groove portion 1071.

A leading end side cutting angle θ1 of the leading end side cut portion 1072 of the groove portion 1071 is defined by the superficial portion 1070 of the developing roller 107 and a line a-a′ passing through the leading end side cut portion 1072 as shown in FIG. 11. Further, a trailing end side cutting angle θ2 is defined by the superficial portion 1070 of the developing roller 107 and a line b-b′ passing through the trailing end side cut portion 1073 as shown in FIG. 11.

In the developing roller 107 used in the developing device 100 according to the present embodiment, the groove portion 1071 is formed such that (leading end side cutting angle θ1)>(trailing end side cutting angle θ2) is satisfied. Note that, in the present embodiment, the groove bottom surface 1074 need not be formed, as long as a groove portion satisfying the above relationship “(leading end side cutting angle θ1)>(trailing end side cutting angle θ2)” is formed.

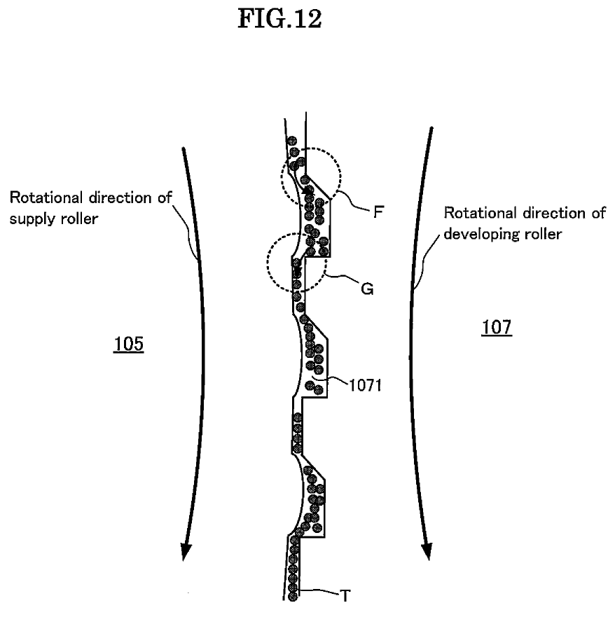

Advantages obtained by forming the groove satisfying the above relationship on the developing roller 107 will next be described. FIG. 12 is a view schematically showing a cross-section of a contact portion (portion denoted by C in FIG. 10) between the developing roller 107 and the supply roller 105 used in the developing device 100 according to the another embodiment of the present invention. In FIG. 12, a reference symbol T schematically denotes toner particles. With reference to FIG. 12, a mechanism for enhancing resettability of the toner particles T in the developing device 100 according to the present embodiment will be described.

The groove portion 1071 having the leading end side cut portion 1072 and trailing end side cut portion 1073 in which the relationship “(leading end side cutting angle θ1)>(trailing end side cutting angle θ2)” is established is formed in the developing roller 107 according to the present embodiment. In the present embodiment, the resettability of the toner particles T is enhanced using the relationship of the angle on the leading end side and that on the trailing end side and a supply method of the toner particles T in the supply roller 105.

In the present embodiment, the toner particles T are supplied to the developing roller 107 by with rotation of the supply roller 105 relative to the developing roller 107. That is, the developing roller 107 and supply roller 105 are rotated in the same direction as each other at the nip portion between them to supply the toner particles T from the supply roller 105 to the developing roller 107. The rotational drive speed of the supply roller 105 is set higher than that of the developing roller 107.

The groove portion 1071 of the developing roller 107 has the leading end side cut portion 1072 and trailing end side cut portion 1073 in which the relationship θ1>θ2 is satisfied. With this configuration, as shown in by F in FIG. 12, new toner particles T can easily be supplied to the groove portion 1071. In addition, the configuration in which the rotational drive speed of the supply roller 105 is higher than that of the developing roller 107 allows new toner particles T to easily enter the groove portion 1071.

When new toner particles T enter the groove portion 1071 as shown by F in FIG. 12, old toner particles T are expected to be pushed out from the groove portion 1071 as shown by G in FIG. 12. The old toner particles T means toner particles that have not been developed on the photoconductor 23 and conveyed back to the developing roller 107.

As described above, according to the present embodiment, it is possible to realize a developing device and an image forming apparatus capable of preventing deterioration of the resettability of the toner particles to prevent excess charge of the toner particles, thereby preventing occurrence of failure caused by an decrease in toner flying property between the developing roller and photoconductor or a change in development characteristics.

### EXAMPLE 2

As the developing roller 107 for the developing device 100 according to the present embodiment, a developing roller having a groove portion in which the leading end side cutting angle θ1=60° and trailing end side cutting angle θ2=30° was produced. Further, as a developing roller for the developing device 100 according to a comparative example, a developing roller having a groove portion in which the leading end side cutting angle θ1=45° and trailing end side cutting angle θ2=45° was produced. The groove pitch of both the developing rollers was set to 80 μm.

The developing device 100 according to the present embodiment and the developing device 100 according to the comparative example respectively incorporating the above developing rollers were mounted in the image forming apparatus 1 shown in FIG. 2 to perform a print test under the conditions described below.

### (Driving Speed)

Photoconductor: 200 mm/sec
Developing roller: 300 mm/sec

(with rotation at the nip portion in the same direction with the photoconductor)
Supply roller: 225 mm/sec

(with rotation at the nip portion in the same direction with the developing roller)

### (Developing Bias, etc.)

Vdc (direct current component): −300 V
Vpp (alternating current, voltage between peaks): 1400 V
Frequency: 3 KHz
Duty (ratio of plus-side component): 60%
Waveform: rectangular wave
Developing gap: 140 μm

The results of the print test under the above conditions were obtained as follows.
(Developing device 100 according to the present embodiment) Solid image density: OD value 1.5, blurring did not occur
(Developing device 100 according to the comparative example) Solid image density: OD value 1.1, blurring occurred

The obtained results will be discussed below. In the developing device according to the present embodiment, a satisfactory solid image density was obtained. It is estimated that this is because agitation between new toner particles and old toner particles was satisfactorily conducted to enhance the resettability, which prevents excess charge of the toner particles to maintain good flying property. On the other hand, in the developing device according to the comparative example, supply of the toner particles was not satisfactorily conducted, so that blurring occurred in sold printing to result in insufficient image density.

As described above, according to the present invention, it is possible to realize a developing device and an image forming apparatus capable of preventing deterioration of the resettability of the toner particles to prevent excess charge of the toner particles, thereby preventing occurrence of failure caused by an decrease in toner flying property between the developing roller and the photoconductor or a change in development characteristics

Further, according to the present invention, it is possible to realize a developing device and an image forming apparatus capable of preventing poor charging of the toner particles to prevent overlapping of the toner particles which incurs waste of the toner.

What is claimed is:

1. A developing device that develops non-magnetic mono component toner using a developing roller having on its surface a plurality of groove portions each of which includes: a leading end side cut portion formed on the leading end side of the developing roller in the rotational direction thereof and having a leading end side cut angle θ1; and a trailing end side cut portion formed on the trailing end side of the developing roller in the rotational direction thereof and having a trailing end side cut angle θ2 and in which a relationship θ1<θ2 is satisfied.

2. The developing device according to claim 1, wherein
toner is supplied to the developing roller by a supply roller that rotates in the reverse direction relative to the rotational direction of the developing roller at the nip portion with the developing roller.

3. A developing device that develops non-magnetic mono component toner using a developing roller and a supply roller,
the developing roller having on its surface a plurality of groove portions each of which includes: a leading end side cut portion formed on the leading end side of the developing roller in the rotational direction thereof and having a leading end side cut angle θ1; and a trailing end side cut portion formed on the trailing end side of the developing roller in the rotational direction thereof and having a trailing end side cut angle θ2 and in which a relationship θ1>θ2 is satisfied,
the supply roller rotating in the same direction as the rotational direction of the developing roller at the nip portion with the developing roller so as to supply toner to the developing roller.

4. An image forming apparatus incorporating a developing device that develops non-magnetic mono component toner using a developing roller having on its surface a plurality of groove portions each of which includes: a leading end side cut portion formed on the leading end side of the developing roller in the rotational direction thereof and having a leading end side cut angle θ1; and a trailing end side cut portion formed on the trailing end side of the developing roller in the rotational direction thereof and having a trailing end side cut angle θ2 and in which a relationship θ1<θ2 is satisfied.

5. An image forming apparatus incorporating a developing device that develops non-magnetic mono component toner using a developing roller and a supply roller,
the developing roller having on its surface a plurality of groove portions each of which includes: a leading end side cut portion formed on the leading end side of the developing roller in the rotational direction thereof and having a leading end side cut angle θ1; and a trailing end side cut portion formed on the trailing end side of the developing roller in the rotational direction thereof and having a trailing end side cut angle θ2 and in which a relationship θ1>θ2 is satisfied,
the supply roller rotating in the same direction as the rotational direction of the developing roller at the nip portion with the developing roller so as to supply toner to the developing roller.
